(19) United States
(12) Patent Application Publication
(10) Pub. No.: US 2020/0077581 A1
(43) Pub. Date: Mar. 12, 2020

(54) VARIABLE HEIGHT-OF-CUT AND GROUND WORKING VEHICLE INCORPORATING SAME

(71) Applicant: THE TORO COMPANY, Bloomington, MN (US)

(72) Inventor: Richard Simon Carter, Great Dunmow (GB)

(21) Appl. No.: 16/563,054

(22) Filed: Sep. 6, 2019

Related U.S. Application Data
(60) Provisional application No. 62/729,632, filed on Sep. 11, 2018.

(51) Int. Cl. A01D 34/74

(52) U.S. Cl. CPC A01D 34/74; A01D 2101/00

(57) ABSTRACT

A variable height-of-cut system for a ground working vehicle including a cutting deck, ground engaging members, and the height-of-cut system. The ground engaging members are rotatably attached to the cutting deck and operable to support the deck relative to a ground surface. The height-of-cut system is adapted to alter a height of the cutting deck relative to the ground surface. The height-of-cut system includes an adjustment plate and a lever. The adjustment plate defines a slot and a plurality of notches extending therefrom. Each notch is adapted to receive the lever and corresponds to a different height of the cutting deck relative to the ground surface when the lever is received therein. The adjustment plate is adapted to move along a longitudinal axis such that the plurality of notches are shifted.

This application claims the benefit of U.S. Provisional Application No. 62/729,632, filed Sep. 11, 2018, which is incorporated herein by reference in its entirety

Embodiments of the present disclosure relate generally to ground working vehicles and, more particularly, to a walk-behind mower incorporating a variable height-of-cut system.

### BACKGROUND

Self-propelled walk-behind mowers are commonly used by homeowners and landscape professionals alike. Walk-behind mowers are adept at mowing small lawns, lawns with numerous obstacles (e.g., trees, shrubs, flowerbeds, and the like) that necessitate intricate trimming maneuvers, and lawns that may otherwise be ill-suited to high-speed riding mowers. Moreover, walk-behind mowers are often used when mowing areas with steep slopes.

Many walk-behind mowers have a variable height-of-cut system to adjust the height of the cutting deck such that, e.g., grass may be cut to different heights. Generally, walk-behind mowers have height-of-cut systems that provide either a discrete adjustment system or an infinite adjustment system.

### SUMMARY

Embodiments described herein may provide a variable height-of-cut system that may include discrete settings with infinite adjustability therebetween. For example, in one embodiment, a ground working vehicle may include a cutting deck, ground engaging members, and the height-of-cut system. The ground engaging members may be rotatably attached to the cutting deck and operable to support the deck relative to a ground surface. The height-of-cut system may be adapted to alter a height of the cutting deck relative to the ground surface. The height-of-cut system may include an adjustment plate and a lever. The adjustment plate may define a slot and a plurality of notches extending therefrom. The lever may be movable within the slot and the plurality of notches (e.g., from the slot to any one of the plurality of notches). Each notch may be adapted to receive the lever and may correspond to a different height of the cutting deck relative to the ground surface when the lever is received therein. The adjustment plate may be adapted to move linearly along a longitudinal axis, parallel to the slot, such that the plurality of notches may be shifted.

In another embodiment, a ground working vehicle may include a cutting deck, ground engaging members, and a height-of-cut system. The ground engaging members may be rotatably attached to the cutting deck and operable to support the deck relative to a ground surface. The height-of-cut system may be adapted to alter a height of the cutting deck relative to the ground surface. The height-of-cut system may include an adjustment plate, a lever, and an adjustment apparatus. The adjustment plate may define a slot and a plurality of notches extending therefrom. The lever may be movable within the slot and the plurality of notches (e.g., from the slot to any one of the plurality of notches). Each notch may be adapted to receive the lever and may correspond to a different height of the cutting deck relative to the ground surface when the lever is received therein. The adjustment apparatus may include an adjustment actuator adapted to move the adjustment plate. The adjustment actuator may include a cam-shaped portion adapted to contact the adjustment plate. The adjustment actuator may be rotated about an adjustment axis to move the adjustment plate such that the plurality of notches may be shifted.

The above summary is not intended to describe each embodiment or every implementation. Rather, a more complete understanding of illustrative embodiments will become apparent and appreciated by reference to the following Detailed Description of Exemplary Embodiments and Claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a perspective view of a ground working vehicle (e.g., a self-propelled walk-behind lawn mower) having a height-of-cut system in accordance with embodiments of the present disclosure;

FIG. 2 is an isolated perspective view of components of the ground working vehicle of FIG. 1 illustrating connections between the height-of-cut system and ground engaging members;

FIG. 3 is another perspective view of the components of FIG. 2;

FIG. 4 is an enlarged isolated perspective view of the height-of-cut system of FIG. 1;

FIG. 5 is an exploded view of the height-of-cut system of FIG. 4;

FIGS. 6A-6C are schematic representations of a cam-shaped portion of an illustrative adjustment apparatus within an opening of an adjustment plate, at three separate positions, in accordance with the height-of-cut system of FIG. 1;

FIG. 7 is a bottom plan view of an illustrative adjustment apparatus in accordance with the height-of-cut system of FIG. 1;

FIG. 8 is a cross-sectional view of the height-of-cut system of FIG. 4, in a first position, taken along a longitudinal axis of an adjustment plate of the height-of-cut system; and

FIG. 9 is a cross-sectional view similar to FIG. 8, with the height-of-cut system in a second position.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated. Unless otherwise indicated, all numbers expressing quantities, and all terms expressing direction/orientation (e.g., vertical, horizontal, parallel, perpendicular, etc.) in the specification and claims are to be understood as being modified in all instances by the term “about.”

Generally speaking, embodiments of the present disclosure may be directed to a height-of-cut (HOC) adjustment system to adjust a cutting height of a deck (e.g., a cutting deck) of a power ground working vehicle (e.g., a self-propelled walk-behind lawn mower). The HOC system may include discrete settings (e.g., to adjust the deck by set increments) and may be infinitely adjustable (e.g., to adjust the deck between the set increments of the discrete settings) using the same HOC system. For example, the HOC system may include discrete settings with an adjustable gate that shifts all of the discrete settings equally. Therefore, the HOC system may be adjusted to calibrate the expected height of the deck with the actual height of the deck and/or may be adjusted to match the height between multiple mowers. Further, in some embodiments, the adjustable gate may include an irregularly-shaped or cam-shaped component or linkage to adjust the discrete settings.

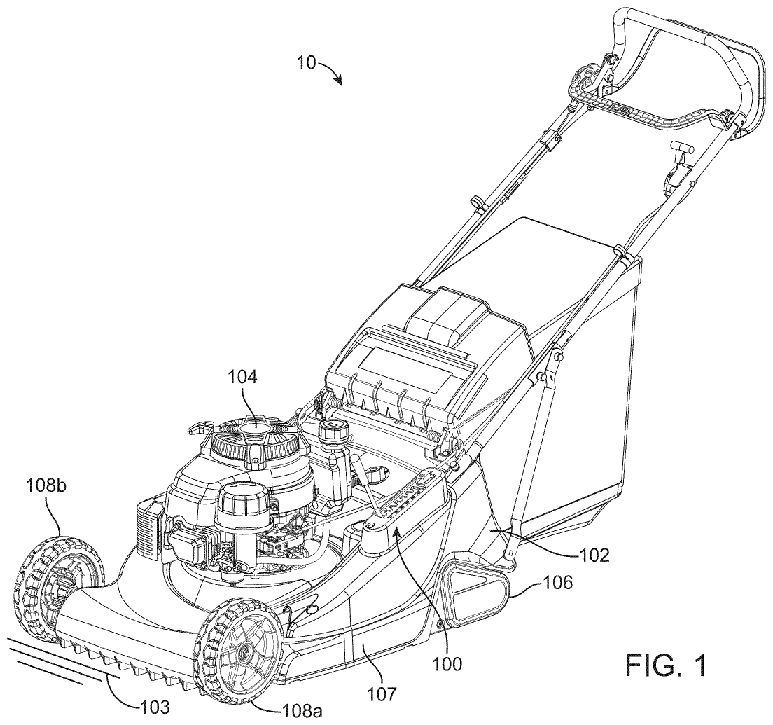

With reference to the figures of the drawing, wherein like reference numerals designate like parts and assemblies throughout the several views, FIG. 1 illustrates a ground working vehicle in accordance with exemplary embodiments of the present disclosure. While shown in this view as a self-propelled, ground working vehicle 10, e.g., a walk-behind lawn mower (also referred to herein simply as a “vehicle” or “mower”), such a configuration is not limiting. That is, while embodiments are described herein with respect to a walk-behind mower, those of skill in the art will realize that this disclosure is equally applicable to other types of mowers, as well as to other types of ground working or turf maintenance vehicles (e.g., spreader/sprayers, debris management systems (e.g., blowers, vacuums, sweeper, etc.), and the like) without limitation.

It is noted that the term “comprises” (and variations thereof) does not have a limiting meaning where this term appears in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 10 while the mower is in an operating configuration, e.g., while the mower 10 is positioned such that roller 106 and wheels 108 rest upon a generally horizontal ground surface 103 as shown in FIG. 1. These terms are used only to simplify the description, however, and not to limit the interpretation of any embodiment described.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

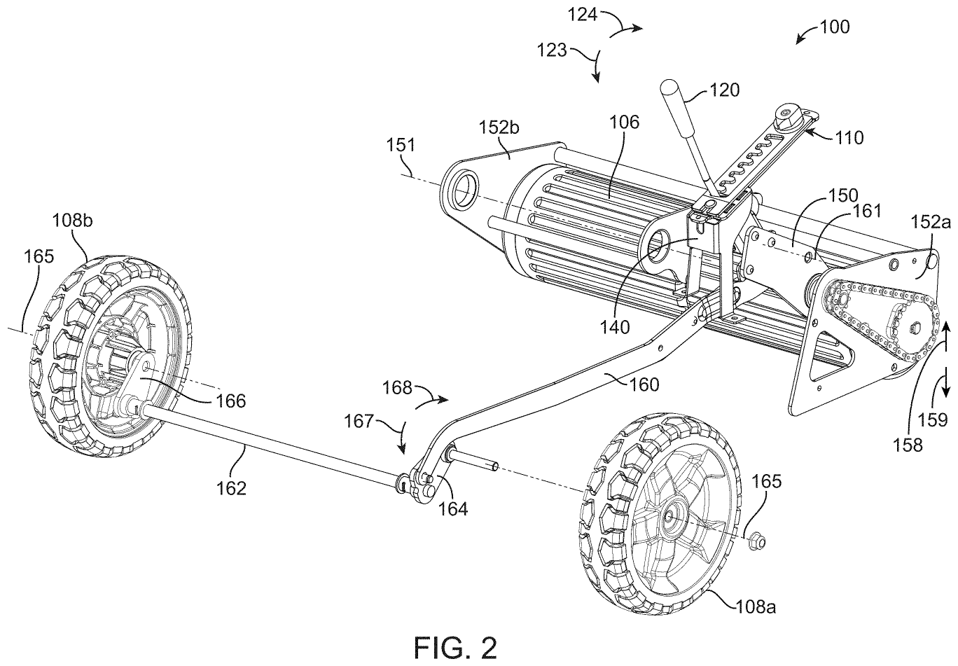

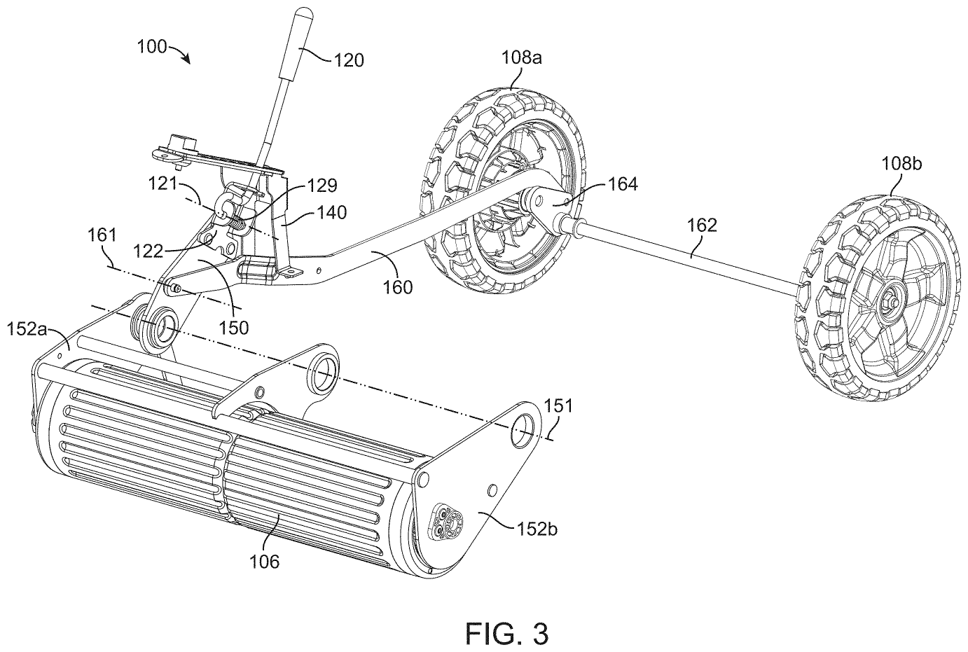

As shown in FIG. 1, the mower 10 may include a frame or chassis 102 that defines a cutting deck 107 of the mower 10 and that supports a prime mover 104. While the prime mover 104 may be configured as most any source of power (e.g., an internal combustion engine, an electric motor, etc.), it is, in the embodiment shown, configured as a combustion engine. The chassis 102 may be supported upon the ground surface 103 by ground-engaging members that, in one embodiment, include a roller 106 (e.g., as better shown in FIGS. 2 and 3) that may be coupled to left and right sides of a rear portion of the mower 10. The roller 106 may be powered by the prime mover 104 (e.g., via a transmission or the equivalent) so that the roller 106 may rotate (relative to the chassis 102) and selectively propel the mower 10 over the ground surface 103. For example, the mower may include a variable speed transmission supported by the chassis 102. The transmission may selectively rotate at least one of the ground-engaging members (e.g., the roller 106) to effect propulsion of the chassis 102 over the ground surface 103. While a single prime mover (e.g., prime mover 104) may power both the vehicle wheels and the implement (e.g., a cutting deck blade), other embodiments may utilize two or more prime movers (e.g., different prime movers for propulsion and for blade power) without departing from the scope of this disclosure. In the illustrated embodiment, a pair of front ground-engaging members (e.g., front wheels 108a, 108b) may support a front portion of the mower 10 in rolling engagement with the ground surface 103. Of course, other drive configurations (e.g., front wheel or all-wheel drive) and other types of ground-engaging members (e.g., wheels, rails, tracks, rollers) located at any suitable position of the chassis 102 (e.g., front, back, etc.), are certainly contemplated within the scope of this disclosure.

The height of the cutting deck 107 may be adjusted relative to the ground surface 103 via a height-of-cut (HOC) system 100. For example, the HOC system 100 may be adapted to alter the height of the cutting deck 107 relative to the ground surface 103. Specifically, the HOC system 100 may effectively adjust the vertical distance between the chassis 102 and the ground engaging members 106, 108 to adjust the height of the cutting deck 107 (e.g., which is defined by the chassis 102) relative to the ground surface 103. As described herein, the HOC system 100 may adjust all of the ground engaging members 106, 108 simultaneously to, e.g., evenly adjust the height of the cutting deck 107 relative to the ground surface 103. However, in some embodiments, the ground engaging members 106, 108 may be adjusted independently from one another to adjust the height of the cutting deck 107 relative to the ground surface 103 (e.g., to modify the angle of the cutting deck 107 relative to the ground surface 103).

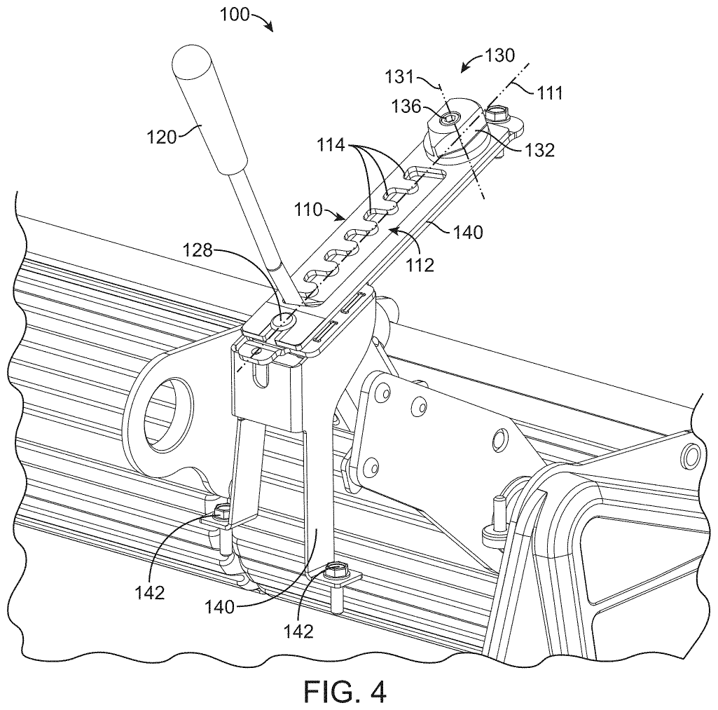

In one or more embodiments, the HOC system 100 may be interconnected with the ground engaging members 106, 108 as shown in FIGS. 2 and 3. The HOC system 100 may include a lever 120 configured to move relative to an adjustment plate 110 (of the HOC system 100), and a mounting bracket 140 coupled to the chassis 102 (chassis not shown in FIGS. 2 and 3), as will be described further herein. The lever 120 may be pivotally coupled to a lever bracket 122 and configured to pivot about axis 121, e.g., as shown in FIG. 3. The lever 120 may be configured to pivot about axis 121 to move into and out of notches 114 (e.g., as shown in FIG. 4). The lever bracket 122 may be fixedly coupled (e.g., riveted) to an HOC arm bracket 150 and the HOC arm bracket 150 may be fixedly coupled to a roller plate 152 (e.g., roller plate 152a in FIG. 3). As shown, the roller 106 may be rotationally coupled between roller plates 152a, 152b such that the roller 106 may interact with and traverse the ground surface 103.

Together, the lever 120, the lever bracket 122, the HOC arm bracket 150, and the roller plates 152 may pivot relative to the chassis 102 about axis 151. For example, when the lever 120 is moved in a rearward direction 124 (relative to the vehicle 10), the roller plates 152 (and the roller 106 rotationally coupled thereto) may move in a generally downward direction 159 relative to the chassis 102. As a result, the roller 106 may move such that the height of the axis 151 increases relative to the ground surface 103, thereby increasing the distance between the chassis 102 and the ground surface 103. In other words, moving the lever 120 in the rearward direction 124 may increase the height of the cutting deck 107 relative to the ground surface 103.

On the other hand, when the lever 120 is moved in a forward direction 123 (relative to the vehicle 10), the roller plates 152 (and the roller 106 rotationally coupled thereto) may move in a generally upward direction 158 relative to the chassis 102. As a result, the roller 106 may move such that the height of the axis 151 decreases relative to the ground surface 103, thereby decreasing the distance between the chassis 102 and the ground surface 103. In other words, moving the lever 120 in the forward direction 123 may decrease the height of the cutting deck 107 relative to the ground surface.

Additionally, the HOC arm bracket 150 may be pivotally coupled to a front link 160 about axis 161, and the front link 160 may be pivotally coupled to a left front bracket 164. The left front bracket 164 and a right front bracket 166 may be rotationally coupled to respective front wheels 108 such that the wheels 108 rotate about axis 165 (e.g., as shown in FIG. 2). Further, the left front bracket 164 and the right front bracket 166 may be fixedly coupled to a front rod 162 (coupled therebetween) such that the left and right front brackets 164, 166 rotate along with the front rod 162. Further yet, the front rod 162 may be journaled to the chassis 102 (not shown) such that the front rod 162 rotates within the chassis 102. In other words, the location of the front rod 162 relative to the chassis 102 may be fixed, but the front rod 162 may rotate (e.g., about the longitudinal axis of the front rod 162) relative to the chassis 102.

When the lever 120 is moved in the rearward direction 124 (relative to the vehicle 10), the movement of the lever 120 may translate the front link 160 and cause the left front bracket 164 to pivot in a clockwise direction 168 (e.g., when looking from the left side of the vehicle 10; see FIG. 2). As a result, the wheels 108 may pivot downwards (e.g., due to the left front bracket 164) and the front bar 162 may effectively move upwards (e.g., relative to the ground surface 103), thereby increasing the distance between the chassis 102 and the ground surface 103. In other words, moving the lever 120 in the rearward direction 124 may increase the height of the cutting deck 107 relative to the ground surface 103.

On the other hand, when the lever 120 is moved in the forward direction 123 (relative to the vehicle 10), the movement of the lever 120 may translate the front link 160 and cause the front bracket 164 to pivot in a counter-clockwise direction 167 (e.g., when looking from the left side of the vehicle 10). As a result, the wheels 108 may pivot upwards and the front bar 162 may effectively move downwards (e.g., relative to the ground surface 103), thereby decreasing the distance between the chassis 102 and the ground surface 103. In other words, moving the lever 120 in the forward direction 123 may decrease the height of the cutting deck 107 relative to the ground surface 103.

Therefore, the lever 120 is configured to adjust both the roller 106 and the front wheels 108 at the same time. In other words, when the lever 120 is moved in the rearward direction 124, both the roller 106 and the front wheels 108 are adjusted to increase the height of the cutting deck 107 and, when the lever 120 is moved in the forward direction 123, both the roller 106 and the front wheels 108 are adjusted to decrease the height of the cutting deck 107.

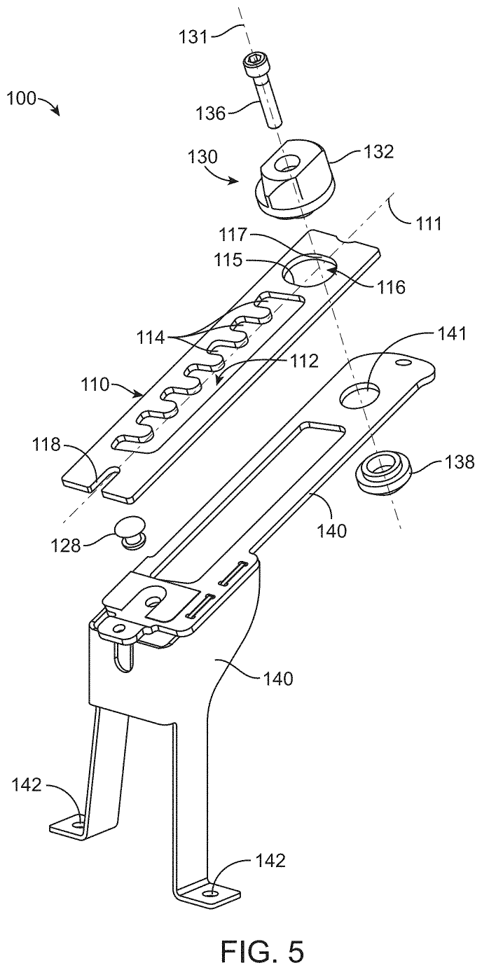

An enlarged view of the HOC system 100 is illustrated in FIGS. 4 and 5. In one or more embodiments, the HOC system 100 may include a mounting bracket 140 coupled to the chassis 102. For example, the mounting bracket 140 may define mounting holes 142 configured to receive fasteners to couple the mounting bracket 140 to the chassis 102. As a result of fixedly coupling the mounting bracket 140 to the chassis 102, the lever 120 may interact with other components of the HOC system 100 and move relative to the chassis 102.

In one or more embodiments, the HOC system 100 may include an adjustment plate 110. The adjustment plate 110 may define a slot 112 and a plurality of notches 114 extending from the slot 112. In some embodiments, the slot 112 may extend along a longitudinal axis 111 of the adjustment plate 110. Further, in some embodiments, the plurality of notches 114 may extend in a direction perpendicular to the longitudinal axis 111. The plurality of notches 114 may define any suitable shaped and/or orientation.

The lever 120 may be movable within the slot 112 and the plurality of notches 114. For example, the lever 120 may move along the longitudinal axis 111 to align with a particular notch 114 and move transverse or perpendicular to the longitudinal axis 111 to enter the particular notch 114. Due to the angular force applied to the lever 120 by the roller plate 152 (which may be fixedly coupled to the lever 120 as described herein) and the weight of the chassis 102, the lever 120 may be biased in the forward direction 123. Therefore, when the lever 120 is received by a notch 114, the lever may contact the front edge of the notch 114. Further, in one or more embodiments, the lever 120 may be biased in a direction (e.g., perpendicular to the longitudinal axis 111) out of the slot 112 and into a notch 114 (e.g., due to torsion spring 129 illustrated in FIG. 3). As such, when no external force is applied to the lever 120, the lever 120 may tend to move into one of the plurality of notches 114. In other words, in order to adjust the HOC system 100, a user may need to apply a force on the lever 120 away from a notch 114 so that the lever 120 may be moved along the slot 112 and, e.g., into another notch 114.

Each notch 114 of the plurality of notches 114 may be adapted to receive the lever 120 and may correspond to a different height of the cutting deck 107 relative to the ground surface 103 when the lever 120 is received therein. The height of the cutting deck 107 relative to the ground surface 103 may be directly correlated to the position of the lever 120. In other words, any movement by the lever 120 (e.g., along the longitudinal axis 111) may result in a change of height to the cutting deck 107. Therefore, the plurality of notches 114 may form discrete or delineated increments by which the cutting deck 107 may be adjusted. In one or more embodiments, the plurality of notches 114 may be arranged linearly along the longitudinal axis 111. As such, linear movement of the lever 120 along the longitudinal axis 111 may result in a change of height to the cutting deck 107 relative to the ground surface 103.

In one or more embodiments, the adjustment plate 110 may be adapted to move such that the plurality of notches 114 are shifted. For example, the adjustment plate 110 may be configured to move relative to the mounting bracket 140. If the plurality of notches 114 are shifted, the height of the cutting deck 107 that corresponded to each notch 114 may also shift. In other words, by moving the adjustment plate 110, the lever 120 may be located in a different position when received by a particular notch 114 and, therefore, the height of the cutting deck 107 relative to the ground surface 103 may also be different. As such, it may be described that moving the lever 120 between notches 114 of the plurality of notches 114 provides a coarse adjustment and moving the adjustment plate 110 (to shift the plurality of notches 114) provides a fine or infinite adjustment.

By shifting the plurality of notches 114, each of the different heights of the cutting deck 107 (relative to the ground surface 103) corresponding to the plurality of notches 114 may be modified simultaneously. Further, the different heights of the cutting deck 107 (relative to the ground surface 103) corresponding to the plurality of notches 114 may be similarly modified (e.g., equally or about equally) by shifting the plurality of notches 114.

In one or more embodiments, the adjustment plate 110 may be adapted to move linearly along the longitudinal axis 111 (e.g., parallel to the slot 112) such that the plurality of notches 114 are shifted. For example, the adjustment plate 110 may define a channel 118 (e.g., extending from an edge of the adjustment plate 110 and along the longitudinal axis 111) and the HOC system 100 may further include a guiding element 128 (e.g., a pin) fixed to the mounting bracket 140 and configured to be received by the channel 118. The guiding element 128 may slide within the channel 118 to assist with ensuring the adjustment plate 110 moves relative to mounting bracket 140 in a generally linear direction (e.g., along or parallel to the longitudinal axis 111).

In one or more embodiments, the HOC system 100 may include an adjustment apparatus 130 adapted to shift the adjustment plate 110. In other words, the adjustment apparatus 130 may interact with the adjustment plate 110 to move the adjustment plate 110 relative to the mounting bracket 140. For example, the adjustment apparatus 130 may include an adjustment actuator 132 to interact with the adjustment plate 110. The adjustment actuator 132 may include any suitable component that may be used to shift the adjustment plate 110 relative to the mounting bracket 140. For example, as shown in FIGS. 4-5, the adjustment actuator 132 may include a knob configured to be rotated by a user.

The adjustment actuator 132 may extend through an opening 116 defined by the adjustment plate 110 and an opening 141 defined by the mounting bracket 140. The adjustment actuator 132 may rotate within the opening 141 and may be configured to contact the edges of the opening 116. The adjustment apparatus 130 may further include a nut 138 and a fastener 136 configured to extend through the adjustment actuator 132 to couple the adjustment actuator 132 and the nut 138. Coupling the adjustment actuator 132 and the nut 138 may help retain the adjustment actuator 132 within the openings 116, 141. Further, the adjustment actuator 132 may rotate about an adjustment axis 131, which may extend along an axis of the fastener 136.

Furthermore, in some embodiments, the adjustment apparatus 130 may be configurable in a locked configuration that restricts movement (e.g., rotation) of the adjustment apparatus 130 (e.g., the adjustment actuator 132) and an unlocked configuration that allows movement (e.g., rotation) of the adjustment apparatus 130 (e.g., the adjustment actuator 132). For example, the fastener 136 may be adapted to be inserted through the adjustment actuator 132 and tightened (or loosened) to place the adjustment apparatus 130 in one of the locked configuration and the unlocked configuration. Specifically, the fastener 136 may tighten the adjustment actuator 132 relative to the nut 138 such that the adjustment actuator may be prevented from moving relative to the adjustment plate 110 and/or the mounting bracket 140 (e.g., due to increased friction).

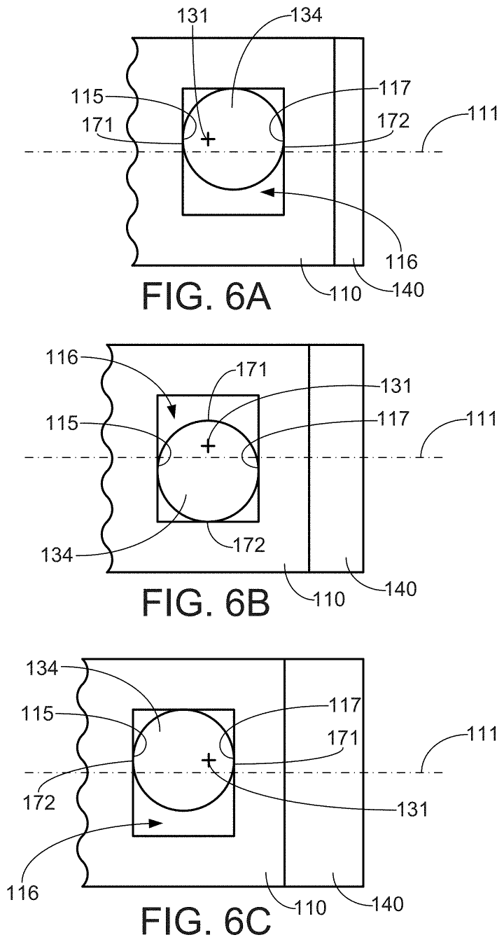

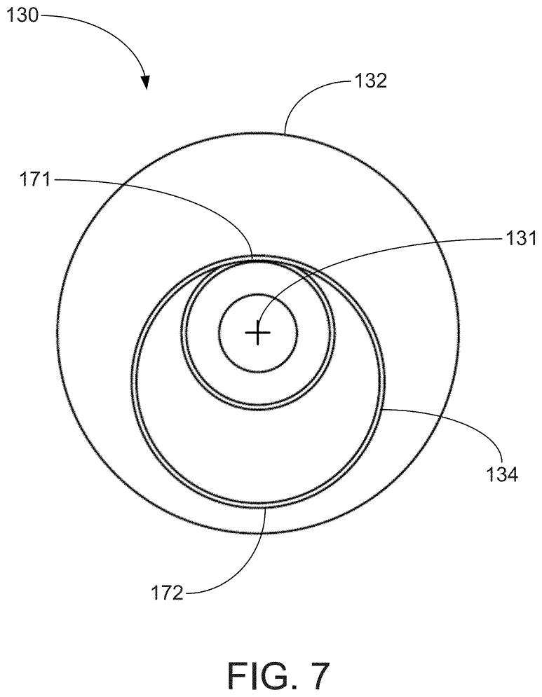

The adjustment actuator 132 may define an irregularly-shaped or cam-shaped portion 134 protruding from the bottom of the adjustment actuator 132, as illustrated in FIG. 7. The cam-shaped portion 134 is shown schematically in FIGS. 6A-6C. The cam-shaped portion 134 may be formed due to the adjustment axis 131 passing through the cam-shaped portion 134 at an offset or non-centered location. As a result, the cam-shaped portion 134 defines a minimum distance between the adjustment axis 131 and a first edge 171 and a maximum distance between the adjustment axis 131 and a second edge 172. As the adjustment actuator 132 pivots about the adjustment axis 131, the locations of the first and second edges 171, 172 move relative to the adjustment axis 131.

As shown in FIG. 5, the opening 116 defined by the adjustment plate 110 may be elongated or oval such that the opening 116 is wider in a direction perpendicular to the longitudinal axis 111 than in a direction along the longitudinal axis 111. The cam-shaped portion 134 of the adjustment actuator 132 may be received within the opening 116. In one or more embodiments, the opening 116 may be sized such that a width or diameter of the cam-shaped portion 134 may be about equal to the width of the opening 116 measured along the longitudinal axis 111 such that, e.g., the cam-shaped portion 134 may always be in contact with a front edge 115 of the opening 116 and a back edge 117 of the opening 116. Additionally, the cam-shaped portion 134 of the adjustment actuator may be positioned within the opening 116 such that the adjustment actuator 132 may only be pivoted 180 degrees. In other embodiments, the adjustment actuator may be pivoted 360 degrees (e.g., fully rotatable) or any other suitable angle.

As the adjustment actuator 132 rotates within the opening 116, the distance between the front edge 115 of the opening 116 and the adjustment axis 131 may change based on the location of the first and second edge 171, 172. For example, the first edge 171 of the cam-shaped portion 134 may be contacting the front edge 115 (e.g., as shown in FIG. 6A), the second edge 172 of the cam-shaped portion 134 may be contacting the front edge 115 (e.g., as shown in FIG. 6C), or an edge of the cam-shaped portion 134 at any location between the first and second edges 171, 172 may be contacting the front edge 115 (e.g., as shown in FIG. 6B). Further, because the adjustment axis 131 may be fixed relative to the mounting bracket 140 (e.g., via nut 138) and the distance between the adjustment axis 131 and the adjustment plate 110 (e.g., the front edge 115 of the opening 116) may change, the adjustment plate 110 may move relative to the mounting bracket 140. For example, as shown in FIGS. 6A-6C, the adjustment plate 110 may move relative to the bracket 140 by different amounts, e.g., as evidenced by the amount of the mounting bracket 140 that may be exposed between positions.

When the adjustment actuator 132 is pivoted, the distance between the adjustment axis 131 and the front edge 115 of the opening 116 may increase or decrease, which results in the adjustment plate 110 moving by that same distance. Therefore, the adjustment actuator 132 may be rotated to infinitely (e.g., infinite iterations within a limited range of motion) adjust or “fine tune” the position of the adjustment plate 110. However, the movement or shifting of adjustment plate 110 may be limited by the difference between the maximum distance defined by the cam-shaped portion 134 (e.g., the distance between the second edge 172 and the adjustment axis 131) and the minimum distance defined by the cam-shaped portion 134 (e.g., the distance between the first edge 171 and the adjustment axis 131).

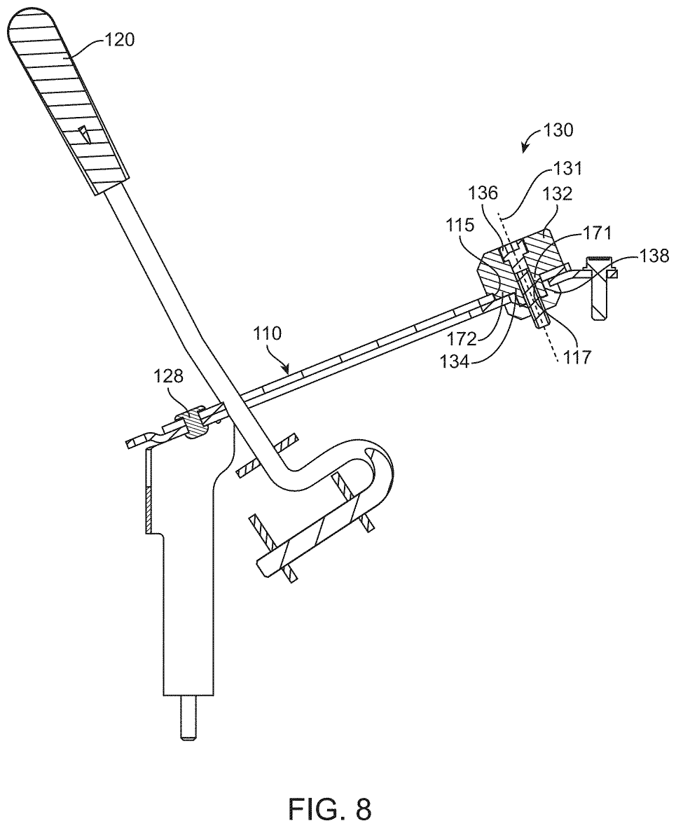

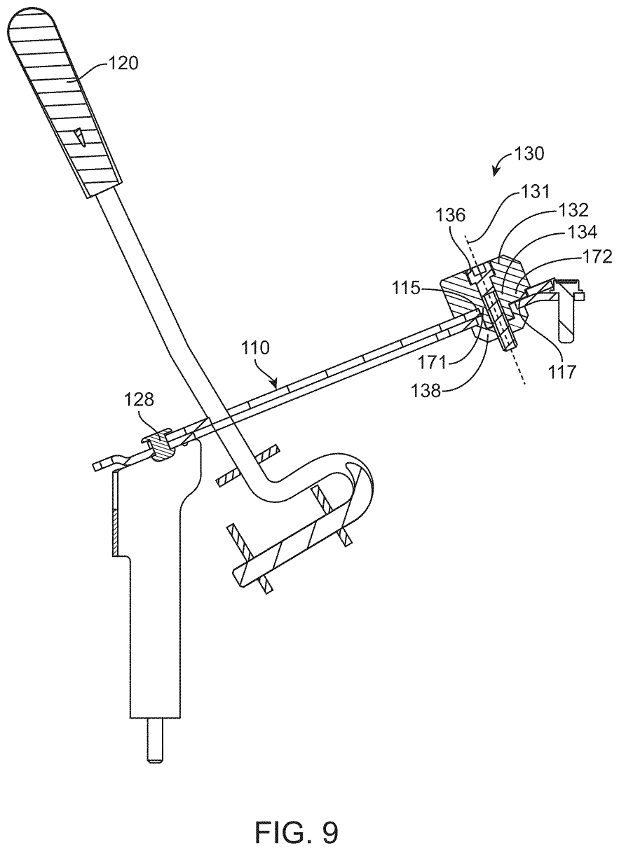

As shown in FIG. 8, the second edge 172 (e.g., the maximum distance) of the cam-shaped portion 134 may contact the front edge 115 of the opening 116 (e.g., the first edge 171 may contact the back edge 117) and, therefore, the adjustment plate 110 may be positioned at a leftmost position relative to the mounting bracket 140 (as viewed in FIG. 8). As shown in FIG. 9, the first edge 171 (e.g., the minimum distance) of the cam-shaped portion 134 may contact the front edge 115 of the opening 116 (e.g., the second edge 172 contacting the back edge 117) and, therefore, the adjustment plate 110 may be positioned at a rightmost position relative to the mounting bracket 140 (as viewed in FIG. 9). Further, when rotating the adjustment actuator 132 to increase the distance between the adjustment axis 131 and the front edge 115 of the opening 116 (e.g., transitioning from the position shown in FIG. 9 to the position shown in FIG. 8), the lever 120 may move in the forward direction (while in the same notch 114) and the cutting deck 107 may be lowered relative to the ground surface 103. In other words, rotating the adjustment actuator 132 to increase the distance between the adjustment axis 131 and the front edge 115 may decrease the height of the cutting deck 107 corresponding to each notch 114 of the plurality of notches 114. Further yet, when pivoting the adjustment actuator 132 to decrease the distance between the adjustment axis 131 and the front edge 115 of the opening 116 (e.g., transitioning from the position shown in FIG. 8 to the position shown in FIG. 9), the lever 120 may move in the rearward direction (while in the same notch 114) and the cutting deck 107 may be raised relative to the ground surface 103. In other words, rotating the adjustment actuator 132 to decrease the distance between the adjustment axis 131 and the front edge 115 may increase the height of the cutting deck 107 corresponding to each notch 114 of the plurality of notches 114.

While shown as a cam surface, other configurations are contemplated herein. In fact, the adjustment apparatus 130 may include any suitable components that may move the adjustment plate 110 relative to the mounting bracket 140. For example, the adjustment apparatus 130 may include a biased cam device, a linear screw, a latching device, etc. Specifically, the biased cam device may include cam-shaped portion similar to that described herein, but with the adjustment plate 110 biased (e.g., by a spring) in a direction along the longitudinal axis 111, towards the cam-shaped portion.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A ground working vehicle comprising:
a cutting deck;
ground engaging members rotatably attached to the cutting deck and operable to support the deck relative to a ground surface; and
a height-of-cut system adapted to alter a height of the cutting deck relative to the ground surface, wherein the height-of-cut system comprises:
an adjustment plate defining a slot and a plurality of notches extending therefrom, and
a lever movable within the slot and the plurality of notches, wherein each notch is adapted to receive the lever and corresponds to a different height of the cutting deck relative to the ground surface when the lever is received therein,
wherein the adjustment plate is adapted to move linearly along a longitudinal axis, parallel to the slot, such that the plurality of notches are shifted.

2. The ground working vehicle of claim 1, wherein each of the different heights of the cutting deck, relative to the ground surface, corresponding to the plurality of notches are modified simultaneously when the plurality of notches are shifted.

3. The ground working vehicle of claim 1, further comprising an adjustment apparatus movable to shift the adjustment plate.

4. The ground working vehicle of claim 3, wherein the adjustment apparatus is configurable in a locked configuration that restricts movement of the adjustment apparatus and an unlocked configuration that allows movement of the adjustment apparatus.

5. The ground working vehicle of claim 1, wherein the plurality of notches are arranged linearly along the longitudinal axis.

6. The ground working vehicle of claim 1, wherein the height-of-cut system further comprises a guiding element adapted to guide the adjustment plate to move linearly along the longitudinal axis.

7. The ground working vehicle of claim 1, wherein the adjustment plate is biased in a direction along the longitudinal axis.

8. A ground working vehicle comprising:
a cutting deck;
ground engaging members rotatably attached to the cutting deck and operable to support the deck relative to a ground surface; and
a height-of-cut system adapted to alter a height of the cutting deck relative to the ground surface, wherein the height-of-cut system comprises:
an adjustment plate defining a slot and a plurality of notches extending therefrom, and
a lever movable within the slot and the plurality of notches, wherein each notch is adapted to receive the lever and corresponds to a different height of the cutting deck relative to the ground surface when the lever is received therein, and
an adjustment apparatus comprising an adjustment actuator adapted to move the adjustment plate, wherein the adjustment actuator comprises a cam-shaped portion adapted to contact the adjustment plate, and wherein the adjustment actuator is rotated about an adjustment axis to move the adjustment plate such that the plurality of notches are shifted.

9. The ground working vehicle of claim 8, wherein the different heights of the cutting deck, relative to the ground surface, corresponding to the plurality of notches are modified simultaneously when the plurality of notches are shifted by the adjustment apparatus.

10. The ground working vehicle of claim 8, wherein the adjustment plate defines an opening through which the adjustment actuator extends, wherein the cam-shaped portion contacts a surface defining the opening to move the adjustment plate.

11. The ground working vehicle of claim 8, wherein the height-of-cut system further comprises a guiding element adapted to guide the adjustment plate to move linearly along a longitudinal axis.

12. The ground working vehicle of claim 8, wherein the adjustment apparatus is configurable in a locked configuration that restricts movement of the adjustment actuator and an unlocked configuration that allows movement of the adjustment actuator.

13. The ground working vehicle of claim 12, wherein the adjustment apparatus further comprises a lock fastener adapted to be inserted through the adjustment actuator and place the adjustment actuator in one of the locked configuration and the unlocked configuration.

14. The ground working vehicle of claim 8, wherein the slot extends along a longitudinal axis and wherein the adjustment plate is biased in a direction along the longitudinal axis.
